(19) United States
(12) Patent Application Publication
(10) Pub. No.: US 2005/0049885 A1
(43) Pub. Date: Mar. 3, 2005

(54) Method of, apparatus for and software for facilitating electronic business transactions

(76) Inventors: Jennifer Ann Johnson, Windsor (AU); David John Jones, Stafford Heights (AU); Gary Richmond Millar, Capalaba (AU); Timothy McDonald, The Gap (AU)

Correspondence Address: Abelman, Frayne & Schwab, 150 East 42nd Street, New York, NY, 10017, US

(21) Appl. No.: 10/650,489

(22) Filed: Aug. 27, 2003

(51) Int. Cl. G06F 17/60

(52) U.S. Cl. 705/1

(57) ABSTRACT

A method of, apparatus for and software facilitating electronic business transactions across a network of interconnected electronic devices including: generating an electronic business call document by way of one of the electronic devices (the calling device), the call document having a call document format selected for use in respect of the calling device; sending the call document to a business transaction centre operatively connected to the calling device; translating the call document to an intermediate format for processing, said processing including identifying another one of the electronic devices (the answering device); translating the call document from said intermediate format to an answering document format selected for use in respect of the answering device; and sending the translated call document to the answering device.

### FIELD OF INVENTION

THIS INVENTION relates to a method of, apparatus for and software for facilitating electronic business transactions. More particularly, the invention relates to business transactions which are conducted over the Internet, but it will be appreciated that the invention is not limited to such transactions.

### BACKGROUND ART

The increasing ubiquity of the Internet has given rise to electronic communications becoming a viable medium for conducting business transactions. However, despite the longstanding impetus of the entrepreneurial urge driving the development of technologies which, streamline business transactions, developments in computer related technologies have resulted in a burgeoning number of transmission and communication protocols, document and data formats, form templates, software application file formats and the like making business transactions at best disjointed and at worst impossible. Several attempts have been made to provide a universal business transaction system, usually resulting in yet another set of protocols and/or formats being added to those already in existence.

Electronic business transactions need not necessarily require the use of a computer as such. For example, EFTPOS terminals are used to perform business transactions and are not generally regarded as being computers. Accordingly, the term “electronic device” in this specification includes “computers” as well as such devices which are not necessarily computers but can interface or communicate therewith as a device operable on a network. Devices should alto be understood as including, where appropriate, multiple devices operatively associated with, or connected to one another. It will also be appreciated that a computer may include such peripheral electronic devices as keyboards, screens, pointing devices, printers, modems, speakers, microphones, mass storage devices, hubs, routers, cash drawers, EFTPOS devices, vehicle monitoring devices, WAP devices and the like. In this specification, unless the context requires otherwise, the term “computer” is to be taken to include such peripheral devices.

One object of the present invention is to provide an improved method of facilitating business transactions. Another object is to provide improved apparatus for facilitating business transactions. Another object is to provide improved software for facilitating business transactions. Another object is to provide trading partners having different business models with the means of interacting with each another in a digital environment. Other objects and advantages of the invention may become apparent from the following description.

### DISCLOSURE OF THE INVENTION

With the foregoing in view, this invention in one aspect resides broadly in a method of transacting business including:
connecting a plurality of electronic devices across a network to a business transaction centre, each electronic device having an electronic identity and a predetermined data transmission protocol for transmitting data and/or receiving data and a capability of performing part of a business transaction;
characterising each electronic device connected to the business transaction centre according to its electronic identity and its data transmission protocol;
creating a database of information relating to a plurality of trading partners having one or more of the plurality of interconnected electronic devices;
generating an electronic business call document by way of one of the plurality of interconnected electronic devices (“the calling device”), the call document having a predetermined call document format;
translating the call document to an intermediate format;
identifying another one of the plurality of interconnected electronic devices (“the answering device”) to which the call document is to be sent by reference to the information in the database;
translating the call document from the intermediate format to a predetermined answering document format; and
sending the translated call document to said answering device.

In another aspect, the invention resides broadly in a method of-transacting business including:
generating an electronic business call document by way of one of a plurality of interconnected electronic devices in a network (“the calling device”), the call document having a predetermined call document format;
translating the call document to an intermediate format;
identifying another electronic device (“the answering device”) to which the call document is to be sent;
translating the call document from the intermediate format to a predetermined answering document format; and
sending the translated call document to said answering device.

In another aspect the invention resides broadly in a method of transacting business including:
creating a database of information relating to a plurality of trading partners having electronic devices connected to each other in a network;
generating an electronic business call document for one trading partner via its electronic device (“the calling device”), the call document having a predetermined call document format;
translating the call document to an intermediate format;
identifying another trading partner by which the call document is to be received via its electronic device (“the answering device”) by reference to information in the call document;
translating the call document from the intermediate format to a predetermined answering document format by reference to the information in the database relating to the other trading partner; and
sending the translated call document to the answering device.

In another aspect, the present invention resides broadly in a system for transacting business, including:
a business transaction centre having means for managing a business transaction among a plurality of trading partners and a plurality of electronic devices in communication with said business transaction centre for data transmission between said centre and each of the trading partners, said business transaction centre having a database of information relating to the identity and characteristics of each electronic device for performing part of a business transaction and processing means for processing data transmissions received from one or more of said plurality of electronic devices and associating them with one or more of others of said plurality of electronic devices by reference to the information in the database to complete the business transaction between the trading partners.

In another aspect, the present invention resides broadly in software for transacting business between trading partners, including:
a data transmission module operable for transmitting data to and from a business transaction centre to and from a plurality of remote electronic devices according to a data transmission protocol;
an identity module operable for identifying the remote electronic devices communicating with the business transaction centre;
a characterising module operatively associated with said identity module and operable to characterise the plurality of remote electronic devices according to their characteristics for performing part of a business transaction; and
a processing module operatively associated with said characterising module and operable to process data transmissions from each of the plurality of remote electronic devices to others of the plurality of remote electronic devices according to the identity and characteristics of the electronic devices to complete a business transaction.

In another aspect, the present invention resides broadly in a method of transacting business including:
running a program on one or more computers so as to integrate software processes, the processes including:
transmitting data to a business transaction centre from a plurality of remote electronic devices according to one or more data transmission protocols;
providing a database of information relating to a plurality of trading partners having one or more of the electronic devices;
identifying an electronic device from which data is being received (“the calling device”) by reference to the information in the database;
processing the data received from the calling device to identify an electronic device to which data is to be sent (“the answering device”), the answering device being operable to receive data in a predetermined answering device format;
converting the data transmitted from the calling device to the answering device format according to the characteristics of the identified answering device; and
transmitting the converted data to the answering device.

Preferably, the method includes sending the call document to a business transaction centre comprising one or more computers. Typically, the call document is sent by a computer which generates the call document. It is preferred that the identification of the answering device (and its associated answering document format) and the translation of the document is carried out in the business transaction centre by reference to the information in the call document.

The call document may relate to any business transaction, and may be, for example, a purchase order for goods and/or services, medical or specialist referral, request for quote, invoice, dispatch or delivery docket, consignment note or other goods movement form or any one of a multiplicity of other business transaction documents. Preferably, the call document includes a plurality of fields for the inclusion of information relevant to the business transaction, one or more of the fields being mandatory, such as, for example, the identity of the party controlling the calling device and the identity of the trading partner to which the business transaction is directed. The document preferably includes a field indicating the type of document relating to the type of business transaction being effected by the document.

The database of information typically includes information relating to identity of the trading partners, the format in which documents are to be sent and received, data transmission protocols for the trading partners electronic devices, authentication data, encryption data and the like. Preferably, the information in the database will be sufficient to enable reference of a plurality of different kinds of call documents relating to different kinds of business transactions. The database also includes information about the kind of business processes conducted within trading partners' own systems. For example, a purchase order may sent by one trading partner to a second trading partner which supports a purchase order acknowledgement, but if a third trading partner receiving a purchase order may not support a purchase order acknowledgement.

In another aspect, the present invention resides broadly in a method of transacting business including:
connecting a plurality of electronic devices across a network to a business transaction centre, each electronic device having an electronic identity and a predetermined data transmission protocol for transmitting data and/or receiving data and a capability of performing part of a business transaction;
characterising each electronic device connected to the business transaction centre according to its electronic identity and its data transmission protocol;
sending a data transmission from one electronic device (“the calling device”) to the business transaction centre via a channel allocated to the data transmission protocol of the calling device by reference to the characteristics of that calling device;
sending the data transmission from the business transaction centre to another electronic device (“the answering device”) via another channel allocated to the data transmission protocol of the answering device by reference to the characteristics of that answering device.

Preferably, the method includes providing trading channels operable to facilitate communications according to each data transmission protocol as software modules within or forming part of the business transaction centre. It will be seen that a data transmission relevant to a part of a business transaction emanating from a calling device may be directed to any other one or more electronic devices to complete a business transaction. For example, one data transmission may include or relate to the call document as described earlier while another data transmission completing the business transaction may include or relate to the translated call document as described earlier. Both data transmissions may relate to a complete business transaction, but it will be appreciated that a business transaction may involve more than one call document being associated with one translated call document, and or one or more call documents may involve more than one translated call document in respect of a single business transaction. For example, if a purchase order for a product is processed by a calling device whereby a call document is transmitted to the business transaction centre for processing, the purchase order in the form of a translated call document for one answering device may relate to the supply of the product and another translated call document for another answering device may relate to a transportation order for delivery of the product. Dispatch of goods involving dispatch documents and/or consignment or waybill documents may also be generated. It will be appreciated, of course, that the electronic devices may include functionality to perform as either a calling device or an answering device or both a calling device and an answering device.

It will be appreciated that the boundary defining what constitutes a business transaction could be somewhat arbitrary. A business transaction may be regarded as any transaction between parties involving the exchange of goods or services for value. However, there may be several steps or stages in such an exchange. For example, completion of a business transaction involving purchase of goods may be defined as consisting of several business transactions, such as, a request for a quotation, sending a purchase order, acceptance of a purchase order, and dispatch of goods the subject of the purchase order. Alternatively, the business transaction may be defined as incorporating all of the actions necessary from the creation of the purchase order to the delivery of the goods. However, the definition chosen to define the business transaction does not affect the ability of the method, apparatus and software of the present invention to accommodate the business transaction because the present invention accommodates many business-to-business communications—the definition of the business transaction as such merely has an effect on the number of instances of the invention being performed.

Preferably, the business transaction centre comprises a computer or a plurality of computers in operative connection with one another. In such form it is preferred that the computer or computers are programmed to perform identification of appropriate electronic devices capable of completing the business transaction being conducted. Suitably, the business transaction centre includes an identification module operable for identifying each electronic device.

In a preferred form, the business transaction centre is programmed to facilitate the following tasks:
authentication and authorisation of calling devices and answering devices;
routing of documents securely (including encryption, data integrity and technical non-repudiation);
transformation at various levels (including format, syntax, data et cetera);
support for a plurality of trading channels (including, for example, HTTPS, SMTP, fax, MQSeries and the like); and
support for a plurality of business documents and types.

It will be appreciated that each electronic device may represent a business offering supply of goods or services or a business seeking to be supplied with goods or services. Advantageously, the invention allows a business seeking to be supplied with goods or services to select from one or a plurality of businesses capable of supplying the goods or services required or offering to supply those goods or services. Suitably, the business transaction centre holds information accessible by each electronic device which enables the identification of suppliers and the goods or services on offer. Preferably, the goods or services on offer, such as catalogues and the like, are detailed in the trading partners' systems. Access thereto may be made possible through the method of the present invention.

In another aspect the invention resides broadly in a method of transacting business, including:
connecting a plurality of electronic devices across a network, each electronic device having a data transmission protocol;
allocating trading channels to the electronic devices according to their respective data transmission protocols;
providing a database of information relating to the data transmission protocol of each electronic device;
processing data transmissions received from one of the plurality of electronic devices for redirection to one or more others of the plurality of electronic devices via the trading channels to which they are connected by reference to the information in the database relating to the data transmission protocols of the other electronic devices.

Preferably, the trading channels and, database form part of the business transaction centre mentioned earlier. It is also preferred that the method includes generating an electronic business call document for one trading partner via its electronic device (“the calling device”), the call document having a predetermined call document format; translating the call document to an intermediate format; identifying another trading partner by which the call document is to be received via its electronic device (“the answering device”) by reference to information in the call document; translating the call document from the intermediate format to a predetermined answering document format by reference to the information in the database relating to the other trading partner; and sending the translated call document to the answering device.

Preferably, some of the data in the data transmission from the calling device relates to the identity of the answering device and some of the data in the data transmission relates to information required for the part of the business transaction to be sent to the answering device once it has been converted in the business transaction centre. It will be appreciated that the conversion of the data transmitted includes conversion of some of the data to the predetermined answering device format and the conversion of data transmission protocols required for transmission of the data to the answering device.

In a preferred form, the electronic devices and/or computers are connected to one another over a computer network, such as, for example, the Internet. It is also preferred that the business transaction centre includes a plurality of channels, referred to hereinafter as trading channels, operatively interposed between the communications network and a process engine. In such form, it is preferred that each trading channel be arranged to provide for communications with one call document format which may be generated by one or more electronic devices. Trading channels may be further arranged to provide communications with related call document formats. It will be seen therefore that a plurality of call document formats may be provided for in the context of the present invention. The process engine is preferably arranged to identify the call document format according to a look-up table or the like according to the identity of the electronic device sending the call document, convert the call document to an intermediate format for further processing, identify the answering electronic device from the information provided in the intermediate format document, convert the intermediate format document into one or more of the answering document formats so identified, and send the answering documents to the respective one or more answering electronic devices.

The method preferably includes running a program on one or more computers so as to integrate software processes including:
remote administration for administering communications between a business transaction centre and a plurality of electronic devices operatively connected thereto;
security for limiting unauthorised access to the business transaction centre;
security measures for securing document content;
receiving call documents from some of the electronic devices, each call document having a call document format;
translating call document formats to an intermediate format and translated documents from the intermediate format to answering document formats;
managing the transmission of answering documents to answering electronic devices;
managing business processes according to the type of business transaction being facilitated;
warehousing documents;
software process integrity, administration and exception handling; and
reporting activity in respect of any one or more of the aforementioned software processes.

Preferably, the answering electronic devices perform as trading partners operatively associated with the business transaction centre as described above.

### BRIEF DESCRIPTION OF THF DRAWINGS

In order that the invention may be more readily understood and put into practical effect, reference will now be made to the accompanying drawing which exemplifies diagrammatically one or more aspects of the invention and wherein:

FIG. 1. is a schematic representation of a system topology for a business transaction system according to the invention.

### DETAILED DESCRIPTION OF THE DRAWING

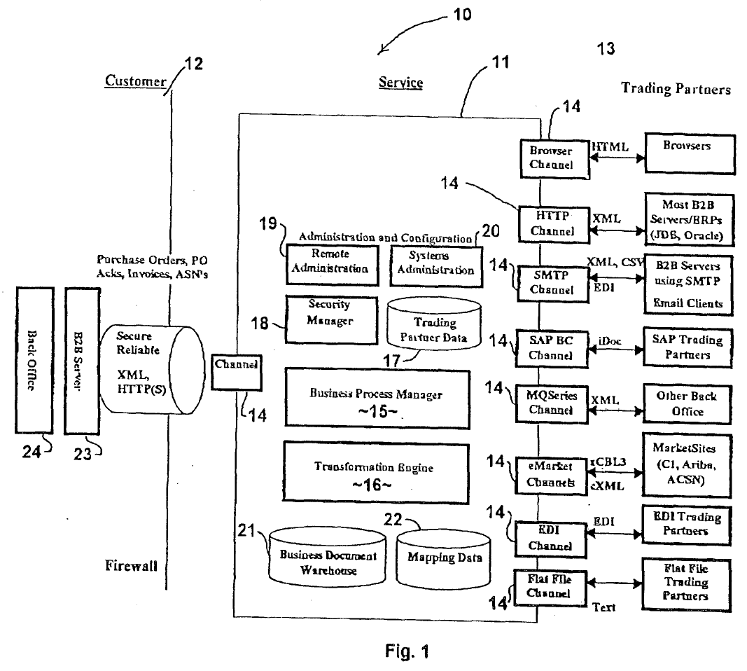

The system topology 10 shown in FIG. 1 includes a business transaction centre 11 operatively connected to a customer 12, being a trading partner acting as a calling party calling for a business transaction to be initiated in relation to supply from one or more trading partners 13 each of which is operatively connected to the business transaction centre. The operative connection of the customers and trading partners to the business transaction centre is, in the embodiment shown, in the form of an Internet connection or the like. The trading partners operatively connected to the business transaction centre may communicate therewith according to any one or more answering party formats exemplified by the eight different communication formats required for the different kinds of system operated by the trading partners including the browsers, B2B servers and/or ERP's (JDE, Oracle); B2B servers using SMTP (email clients); SAP trading partners; their back office trading partners; MarketSites (C1, Ariba, ACSN) ; EDI trading partners; Flat file trading partners. Each type of trading partner is operatively connected to a respective trading channel 14 as is the customer. More trading partners and/or channels may be added, the transaction centre being designed to be extensible to accommodate and/or support protocols now and in the future.

Each trading channel is operatively associated with a business process manager 15 which is operatively associated with a transformation engine 16 which transforms any call document sent from the customer through the customer's trading channel to an intermediate format for transformation in the transformation engine to a format suitable for the particular trading partner type, the trading partner type being operatively recorded in a trading partner databank 17. The call document format may be any format which achieves the required functions of being transmitted and received whist preserving the information required for the business transaction. Also operatively associated with the business process manager is a security manager 18, a remote IS administration 19 and a systems administration 20.

The business process manager is also operatively associated with a business document warehouse 21 and a mapping databank 22 to assist in the processing of call documents to the intermediate format and subsequent transformation to an answering document format. It will be appreciated that upon receipt of an answering document from the business transaction centre, the trading partner may transmit a response in which case the process apparatus and software of the invention is used for the return path, the trading partner operatively functioning as a calling party and the customer operatively functioning as an answering party. The format for documents of the return path maybe different from that already described. The customer's system includes a B2B server 23 operatively associated with a customer's back office 24.

In order that the invention may be more readily understood and put into practical effect, reference will now be made to one or more business transactions in respect of the invention. For example, a purchase order, change order, request for quote, a quotation, invoice, remittance advice, work order, ASN or receipt maybe generated by a customer as a call document in the customer's back office. Within the trading channel communications include a format, a protocol and packaging of the document for transmission thereof in XML via HTTP(S). The communication between the customer and the customer's trading channel would be of a secure and a reliable form. For example where the business document is in the form of an XML document, XML tags may be used to identify data fields and the data contained in particular fields. In the case of a purchase order, the back office produces the purchase order in their normal document format on their back office computer system and uploads the purchase order to the B2B server which transmits the document over the Internet to a trading channel within the business transaction centre. The purchase order is then decrypted, authenticated, and authorised, the document type being identified and the format identified. Upon identification of the format, the document is transformed into the intermediate format for further processing by the process engine or business process manager. The particular trading partner is identified from the business document whereupon the format suitable for transmission of the business document (purchase order) to the trading partner is identified, the document transformed into the appropriate format for the trading partner and the document transmitted to the trading partner for further processing.

Upon receipt of the business document (purchase order) from the customer (through the business transaction centre of or forming part of the present invention), a purchase order acknowledgement is returned through the business transaction centre to the customer. In some cases, the purchase is fulfilled by accommodating payment for the purchase of goods and services through the business transaction centre, acknowledgement of payment resulting in the dispatch of goods or provision of services to the customer. Delivery of goods may involve a transportation business partner providing the service of transporting the goods from the trading partner supplying the goods to the customer ordering the goods, in which case business documents effecting the transportation of goods are generated and dispersed or transmitted to the appropriate trading partners through the business transaction centre of or forming part of the present invention.

It is believed that the method, apparatus and software of the present invention provides advantages in facilitating electronic business transactions without adding, of itself, to the burgeoning number of electronic data transmission regimes. Trading partners making use of connection to the business transaction system of the present invention for one particular type of business transaction should be able to achieve the most out of their relationship once it is recognised that many other types of business transaction may be completed by virtue of the present invention. The collaborative capabilities among businesses include (but are not limited to):
Procurement—purchase order outbound, purchase order acknowledgement inbound and purchase order change outbound;
advanced procurement—purchase order status request outbound, purchase order status response inbound, advanced shipping notice inbound, vendor held stock outbound, invoice inbound;
sales order—purchase order inbound, purchase order acknowledgement outbound and purchase order change inbound;
advanced sale order—purchase order status request inbound, purchase order status response outbound, advanced shipping notice outbound, vendor held stock inbound, invoice outbound;
contracts management—request for quote outbound, response to quote inbound;
payment management—remittance advice outbound.

It will be appreciated that additional business-to-business capabilities can be added to the above with a view to accommodating any kind of business transaction.

In providing the connection to the business transaction centre, a service is provided to trading partners aimed at simplifying and rationalising their current systems that are used to interact with other trading partners. The service performs on behalf of the trading partner by sending and receiving all business documents to and from other trading partners. The service facilitates the adoption of collaborative business processes with trading partners. The topology described above accommodates the expansion of system capabilities to handle substantially all types of business transaction. The business transaction centre is programmed to support different types of trading channel, different business document standards, security standards, transformation, trading partner management and business document warehousing. Each trading partner would normally require only one trading channel. Connectivity to the business transaction centre may involve third party connectivity software, such as MQSeries. Usually connectivity is performed over HTTPS. Trading partners will usually have a “back-office” for both inbound and outbound documents.

The business transaction centre is operable to perform a plurality of roles including authentication and authorisation of trading partners and of the business transactions, or parts of business transactions, they can perform; routing of documents securely; transformation at various levels as herein described; support for a plurality of trading channels; support for a plurality of business document standards, formats and types; replay, auditing and reporting of warehoused documents; interaction with the business transaction center for management of configuration and administrative settings; managing technical details; supplying the trading channel between, the business transaction centre and the trading partner or customer; reporting operational activity to those responsible for operation of the business transaction centre.

It is anticipated that there can be several special types of relationship between different trading partners making use of the method, apparatus and software of the present invention. For example, “integrated trading partners” may be defined as those which are connected to one another via the business transaction but use identical or relatively compatible transmission protocols, such as protocols closely related to hypertext. For example, business partners both using XML over HTTPS may be regarded as integrated trading partners. “Non-integrated trading partners” may use some other file transmission protocol such as SMTP or FTP, or other file formats such as PDF. It will be seen that integrated trading partners can form a closer relationship than non-integrated trading partners by ensuring that the trading partners have the necessary data to fully integrate a business document into their system. It is believed that such an arrangement will allow integrated trading partners to more efficiently process the business document. One way to circumvent any perceived disadvantage of being a non-integrated trading partner making use of the present invention may involve the establishment of a “marketplace” acting as a trading partner with respect to the business transaction centre, but providing an indirect connection for a plurality of trading partners having a common transmission protocol. The marketplace may therefore be set up as an integrated trading partner as herein described.

Although the invention has been described with reference to one or more specific examples, it will be appreciated by persons skilled in the art that the invention may be embodied in other forms within the broad scope and ambit of the invention as claimed by the following claims.

1. A method of transacting business including:
connecting a plurality of electronic devices across a network to a business transaction centre, each electronic device having an electronic identity and a predetermined data transmission protocol for transmitting data and/or receiving data and a capability of performing part of a business transaction;
characterising each electronic device connected to the business transaction centre according to its electronic identity and its data transmission protocol;
creating a database of information relating to a plurality of trading partners having one or more of the plurality of interconnected electronic devices;
generating an electronic business call document by way of one of the plurality of interconnected electronic devices (“the calling device”), the call document having a predetermined call document format;
translating the call document to an intermediate format;
identifying another one of the plurality on interconnected electronic devices (“the answering device”) to which the call document is to be sent by reference to the information in the database;
translating the call document from the intermediate format to a predetermined answering document format; and
sending the translated call document to said answering device.

2. A method according to claim 1, including sending the call document to a business transaction centre comprising one or more computers.

3. A method according to claim 1, wherein the database of information includes information relating to identity of the trading partners, the format in which documents are to be sent and received, data transmission protocols for the trading partners electronic devices, authentication data, and encryption data.

4. A method of transacting business including:
generating an electronic business call document by way of one of a plurality of interconnected electronic devices in a network (“the calling device”), the call document having a predetermined call document format;
translating the call document to an intermediate format;
identifying another electronic device (“the answering device”) to which the call document is to be sent;
translating the call document from the intermediate format to a predetermined answering document format; and
sending the translated call document to said answering device.

5. A method according to claim 4, including sending the call document to a business transaction centre comprising one or more computers.

6. A method of transacting business including:
creating a database of information relating to a plurality of trading partners having electronic devices connected to each other in a network;
generating an electronic business call document for one trading partner via its electronic device (“the calling device”) the call document having a predetermined call document format;
translating the call document to an intermediate format;
identifying another trading partner by which the call document is to be received via its electronic device (“the answering device”) by reference to information in the call document;
translating the call document from the intermediate format to a predetermined answering document format by reference to the information in the database relating to the other trading partner; and
sending the translated call document to the answering device.

7. A method according to claim 6, including sending the call document to a business transaction centre comprising one or more computers.

8. A method according to claim 6, wherein the database of information includes information relating to identity of the trading partners, the format in which documents are to be sent and received, data transmission protocols for the trading partners electronic devices, authentication data, and encryption data.

9. A system for transacting business, including:
a business transaction centre having means for managing a business transaction among a plurality of trading partners and a plurality of electronic devices in communication with said business transaction centre for data transmission between said centre and each of the trading partners, said business transaction centre having a database of information relating to the identity and characteristics of each electronic device for performing part of a business transaction and processing means for processing data transmissions received from one or more of said plurality of electronic devices and associating them with one or more of others of said plurality of electronic devices by reference to the information in the database to complete the business transaction between the trading partners.

10. A system according to claim 9, wherein the database of information includes information relating to identity of the trading partners, the format in which documents are to be sent and received, data transmission protocols for the trading partners electronic devices, authentication data, and encryption data.

11. Software for transacting business between trading partners, including:
a data transmission module operable for transmitting data to and from a business transaction centre to and from a plurality of remote electronic devices according to a data transmission protocol;
an identity module operable for identifying the remote electronic devices communicating with the business transaction centre;
a characterising module operatively associated with said identity module and operable to characterise the plurality of remote electronic devices according to their characteristics for performing part of a business transaction; and
a processing module operatively associated with said characterising module and operable to process data transmissions from each of the plurality of remote electronic devices to others of the plurality of remote electronic devices according to the identity and characteristics of the electronic devices to complete a business transaction.

12. A method of transacting business including:
running a program on one or more computers so as to integrate software processes, the processes including:
transmitting data to a business transaction centre from a plurality of remote electronic devices according to one or more data transmission protocols;
providing a database of information relating to a plurality of trading partners having one or more of the electronic devices;
identifying an electronic device from which data is being received (“the calling device”) by reference to the information in the database;
processing the data received from the calling device to identify an electronic device to which data is to be sent (“the answering device”), the answering device being operable to receive data in a predetermined answering device format;
converting the data transmitted from the calling device to the answering device format according to the characteristics of the identified answering device; and
transmitting the converted data to the answering device.

13. A method according to claim 12, including sending the call document to a business transaction centre comprising one or more computers.

14. A method according to claim 13, wherein the translation of the document is carried out in the business transaction centre by reference to the information in the call document.

15. A method according to claim 14, wherein the database of information includes information relating to identity of the trading partners, the format in which documents are to be sent and received, data transmission protocols for the trading partners electronic devices, authentication data, and encryption data.

16. A method according to claim 15, wherein the information in the database is sufficient to enable reference of a plurality of different kinds of call documents relating to different kinds of business transactions.

17. A method of transacting business including:
connecting a plurality of electronic devices across a network to a business transaction centre, each electronic device having an electronic identity and a predetermined data transmission protocol for transmitting data and/or receiving data and a capability of performing part of a business transaction;
characterising each electronic device connected to the business transaction centre according to its electronic identity and its data transmission protocol;
sending a data transmission from one electronic device (“the calling device”) to the business transaction centre via a channel allocated to the data transmission protocol of the calling device by reference to the characteristics of that calling device;
sending the data transmission from the business transaction centre to another electronic device (“the answering device”) via another channel allocated to the data transmission protocol of the answering device by reference to the characteristics of that answering device.

18. A method according to claim 16, including providing trading channels operable to facilitate communications according to each data transmission protocol as software modules within or forming part of the business transaction centre.

19. A method of transacting business, including:
connecting a plurality of electronic devices across a network, each electronic device having a data transmission protocol;
allocating trading channels to the electronic devices according to their respective data transmission protocols;
providing a database of information relating to the data transmission protocol of each electronic device;
processing data transmissions received from one of the plurality of electronic devices for redirection to one or more others of the plurality of electronic devices via the trading channels to which they are connected by reference to the information in the database relating to the data transmission protocols of the other electronic devices.

20. A method according to claim 17, including a plurality of channels, referred to hereinafter as trading channels, operatively interposed between a communications network and a process engine, each trading channel being arranged to provide for communications with one call document format which may be generated by one or more electronic devices.

21. A method according to claim 18, wherein the trading channels are further arranged to provide communications with related call document formats.

22. A method, according to claim 19, including running a program on one or more computers so as to integrate software processes including:
remote administration for administering communications between a business transaction centre and a plurality of electronic devices operatively connected thereto;
security for limiting unauthorised access to the business transaction centre;
receiving call documents from some of the electronic devices, each call document having a call document format;
translating call document formats to an intermediate format and translated documents from the intermediate format to answering document formats;
managing the transmission of answering documents to answering electronic devices;
managing business processes according to the type of business transaction being facilitated;
warehousing documents;
software process integrity, administration and exception handling; and
reporting activity in respect of any one or more of the aforementioned software processes.

23. Software operable on one or more computers adapted to integrate the software processes substantially as hereinbefore described with reference to FIG. 1.

24. A method of transacting business substantially as hereinbefore described with reference to FIG. 1.

25. A system for transacting business substantially as hereinbefore described with reference to FIG. 1.
